(19) United States
(12) Patent Application Publication
(10) Pub. No.: US 2006/0146031 A1
(43) Pub. Date: Jul. 6, 2006

(54) Wireless touch-control panel and information process system using the same

(76) Inventors: Hui-Chen Wang, Taipei (TW); Kai-Chen Tien, Taipei (TW); Wei-Huan Chou, Taipei (TW); Chi-Fen Chang, Taipei (TW); Shu-Hua Lai, Taipei (TW); Ming-Hui Chen, Taipei (TW)

Correspondence Address: HARNESS, DICKEY & PIERCE, P.L.C., P.O. BOX 8910, RESTON, VA, 20195, US

(21) Appl. No.: 11/272,072

(22) Filed: Nov. 14, 2005

(30) Foreign Application Priority Data
Jan. 5, 2005 (TW) 94200172

(51) Int. Cl. G09G 5/00

(52) U.S. Cl. 345/173

(57) ABSTRACT

A wireless touch-control panel and an information process system applied to the touch-control panel. The information process system has a portable information process device, such as a notebook computer, a personal data assistance or other similar products, a touch-control panel providing a sensor plane allowing the user to touch, a sensor circuit to receive and identify the input signal, generated when the user touches the touch-control panel, an output corresponding signal, and a wireless module to transmit the signal output via the sensor circuit to a wireless receiving module of the portable information process device through a built-in antenna.

### CROSS-REFERENCE TO RELATED APPLICATIONS

This non-provisional application claims priority under 35 U.S.C. § 119(a) on Patent Application No(s). 094200172 filed in Taiwan on Jan. 5, 2005, the entire contents of which are hereby incorporated by reference.

### BACKGROUND OF THE INVENTION

1. Field of Invention

The present invention relates in general to a wireless touch-control panel, and more particularly, to a wireless touch-control panel operative to wirelessly control operation of a portable information process device.

2. Related Art

The advancement in information technology has provided various types of portable information process devices such as notebook computers, flat-panel computers, and personal data assistants. The portability of these information process devices provides great convenience to the user. However, while using these portable information process devices, external input devices, such as the mouse, are often required, which causes great inconvenience in portability and assembly. Therefore, many portable information process devices, particularly the notebook computers, include a built-in touch-control panel, allowing the user to touch controlling the cursor positions and function selections.

For a notebook computer 5 as shown in FIG. 1, the touch-control panel 20 is located at the lower portion under the keyboard 10. In operation, the user often needs to place both hands towards the keyboard 10 and is supported by the main body of notebook computer to maintain a comfortable gesture for typing on the keyboard 10. While using the touch-control panel 20, the fingers have to rise higher than the lower edge 30 of the notebook main body. This makes the hands tired after using the computer for a long time, particularly while using those thick notebook computers. Further, as an additional surface area is required for installing the touch-control panel 20, the notebook computer 5 that includes the built-in touch control panel 20 is typically larger than the notebook computer (such as the IBM notebook computer) that uses point touch-control. If the touch-control panel 20 can be removed, the position of the keyboard 10 of the notebook computer 5 can be moved towards the lower edge, allowing the user who used to use a desktop computer, to operate the notebook computer 5 more comfortably. In addition, as the volume occupied by the touch-control panel 20 is no longer required, more compact notebook computers can be fabricated.

In addition, when the user connects the notebook computer to a projector for presentation or a large-screen television to watch movies, the user will not always stand next to the notebook computer 5. Therefore, a person is required to stay next to the notebook computer for turning pages while using the projector for presentation. Further, the user has to go back to the notebook computer to perform pause, fast-forward, rewind, and volume adjustment operations.

There is thus a substantial need to provide a wireless mobile touch-control panel to remotely control an information process device, such, that the physical position of the user will not be limited for performing various operations.

### SUMMARY OF THE INVENTION

A wireless touch-control panel and an information process device using the wireless touch-control panel are disclosed. The wireless touch-control panel is provided to remotely control operations of the information process device. A remote control module is built in the wireless touch-control panel, such, that wireless control signals can be generated and transmitted to the information process. The information process device, preferably a portable information process device, includes a built-in wireless module for receiving the control signals, such, that the user can perform remote control operation of the information process system.

In one embodiment, the wireless touch-control comprises a touch-control panel that has a sensor plane allowing the user to touch, to generate input signals, a sensor circuit for receiving and identifying the input signals, to output a control signal, a built-in antenna to transmit the control signal, and a wireless module built in the information process device for receiving the control signal. Preferably, the built-in antenna includes a directionless antenna. The information process device may further comprise a wireless receiving module for receiving the control signal.

The wireless touch-control panel thus allows the user to control the information process device at any location within a specified range.

### BRIEF DESCRIPTION OF THE DRAWINGS

The present invention will become more fully understood from the detailed description given in the illustration below only, and thus does not limit the present invention, wherein:

FIG. 1 shows a conventional notebook computer and the touch-control panel thereof;

FIG. 2 shows an embodiment of an information process system;

FIG. 3A shows a first embodiment of a wireless touch-control panel;

FIG. 3B shows a second embodiment of a wireless touch-control panel; and

FIG. 4 shows the signal transmission flow chart of the wireless touch-control panel.

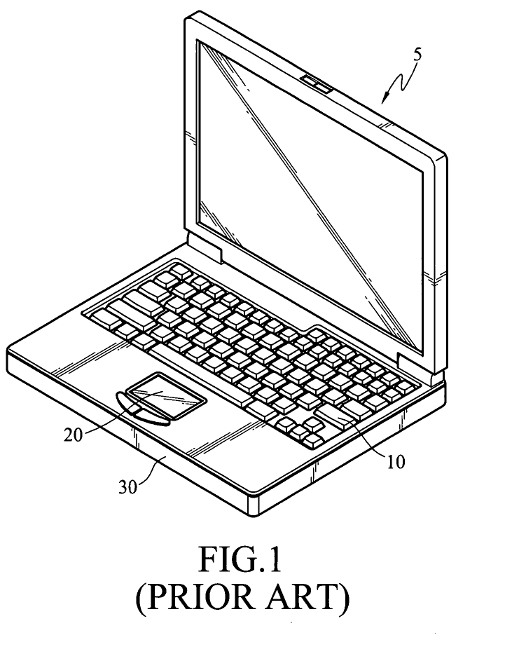

### DETAILED DESCRIPTION OF THE INVENTION

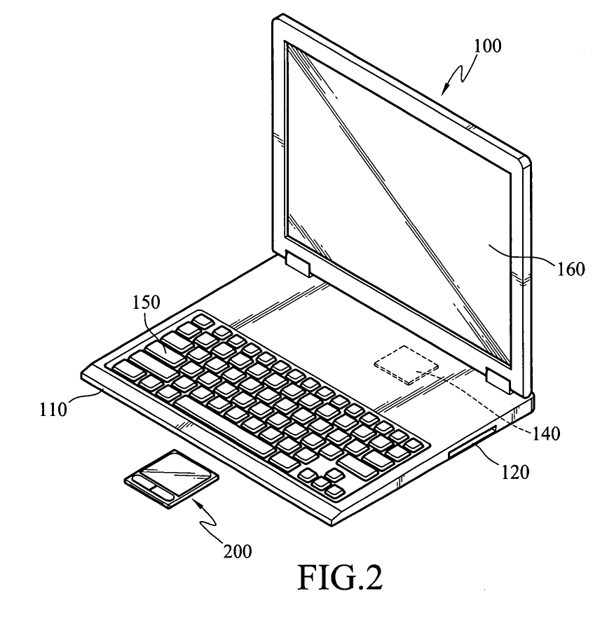

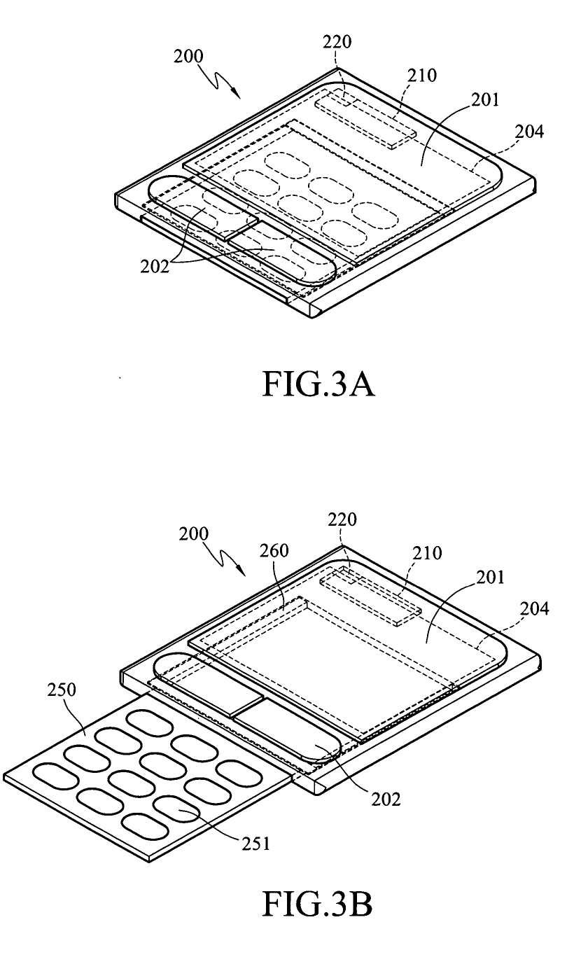

Referring to FIGS. 2 and 3A, an information process system includes a portable information process device 100 and a wireless touch-control panel 200. The portable information process device 100 includes a slot 120, a keyboard 150, a display interface 160 and a wireless receiving module 140. The wireless touch-control panel 200 includes a sensor plane 201, a sensor circuit 204, a built-in antenna 220 and a wireless module 210.

The portable information process device 100 includes a notebook computer, a flat-panel computer or a personal data assistant, for example. The slot 120 can be formed at a side surface of the portable information process device 100. The wireless touch-control panel 200, which is not in use, can be inserted into the slot 120. The wireless touch-control panel 200 is ejected from the slot 120 by simply pressing the touch-control panel 200 inwardly. The slot 120 can also be installed at other positions of the portable information process device 100 as desired, and various types of mechanisms can be used to release the wireless touch-control panel 200 from the slot 120. In FIG. 2, the wireless touch-control panel 200 does not have to be fixed at the lower portion of the main body under the keyboard 150. Thus the keyboard 150 can be installed at the lower portion of the main body. Therefore, the user can use the keyboard 150 more comfortably. Further, the wireless touch-control panel 200 is not limited to the thickness of the portable information process device. Finally, without the built-in wireless touch-control panel 200, the portable information process device 100 can be fabricated compactly.

The portable information process device 100 includes a wireless receiving module 140 for receiving signals transmitted from the wireless touch-control panel 200. The wireless receiving module 140 is integrated into a system chip. The communication of the wireless receiving module 140 includes radio frequency (RF) waves, such as ADF7012, suitable for low-data rate transmission in a short distance. The operation frequency of ADF7012 is between 50 MHz and 1 GHz, which is suitably for use in an RF wireless remote control and sensor. This type of low-data rate wireless communication has a data rate up to 150 Kbps on an ISM band. Bluetooth wireless transmission can also be used. For example, a Bluetooth chip, such as BRF6150, operative to support adaptive frequency hopping, expands the synchronous communication and overcomes the compatibility problem of the Bluetooth system. This type of chip allows two operations to coexist at 2.45 GHz. Other communication, such as 802.11b or 802.1 μg WiFi communication protocol, typically used for long-distance communication, can also be used.

Referring to FIGS. 3A and 3B, the wireless touch-control panel 200 includes a sensor plane 201 allowing the user to touch-generating a sensor signal. In this embodiment, the wireless touch-control panel 200 includes a capacitor-type touch-control panel, having an array of transparent electrodes (not shown). When the user touches the touch-control panel, an electricity through is generated to induce change of the capacitor, to induce a current to inspect the coordinate. In this embodiment, a voltage effect is used to form a constant at four corners of the sensor plane 201. When the user touches the sensor plane 201, the electric field generates a current. Such a current is inspected and identified by a sensor circuit 204 under the sensor plane 201, to generate a corresponding signal. The touch-location can be calculated according to the distances needed for the current to flow to four corners. Two control keys 202 formed at the lower portion of the sensor plane 201 are designed to serve as the right and left click buttons of a mouse. A wireless module 210 is built in the wireless touch-control panel 200. The signal generated by the sensor circuit 204 is output via a directionless built-in antenna 220 to the wireless receiving module 140 of the portable information process device 100. Thereby, the sense signal generated by touching the sensor plane 201 can be transmitted to the portable information process device 100 to execute commands, such as moving up or down the cursor on the display interface 160.

The wireless touch-control panel 200 may further comprise a remote-control module 250, using an internal guiding track 260, allowing the remote-control module 250 to fluently slide into the wireless touch-control panel 200, and pull out for application. The remote-control module 250 includes a plurality of functional keys 251 for transmitting commands, to execute corresponding functions in the portable information process device 100. The built-in functions of the keys 251 include volume control, switch on/off, or page-down, for example. Some of the functional keys 251 may be allocated by program allowing the user to execute certain operation more quickly. The remote-control module 250 and the portable information process device use the RF microwave protocol, Bluetooth wireless protocol or wireless transmission communication protocols 802.11b and 802.11g for signal transmission. These types of communication are more flexible compared to remote control using infrared technique. The user can control operation with less orientation and distance limitation.

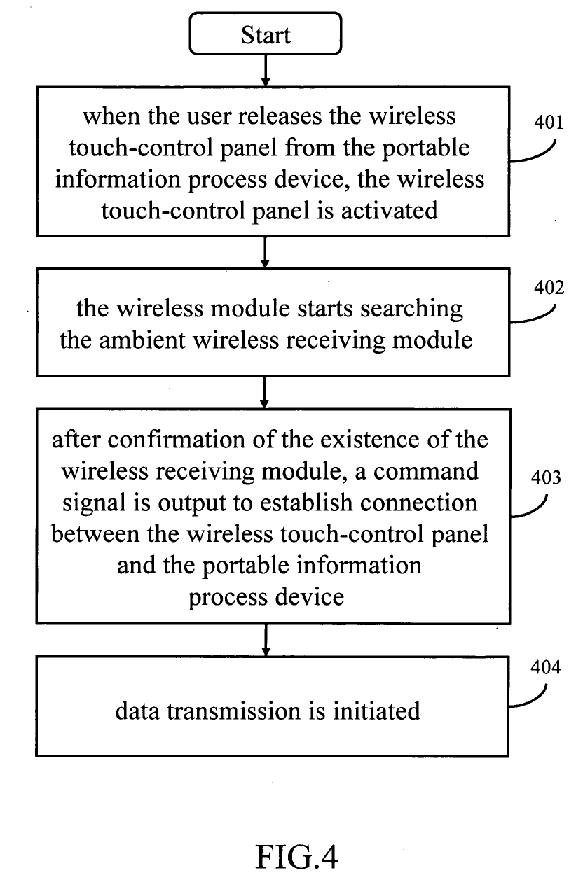

FIG. 4 shows the wireless transmission process of the touch-control panel. In step 401, when the user releases the wireless touch-control panel 200 from the portable information process device 100, the wireless touch-control panel 200 is activated, and the wireless module 210 starts searching the ambient wireless receiving module 140 in step 402. In step 403, after confirmation of the existence of the wireless receiving module 140, a command signal is output to establish connection between the wireless touch-control panel 200 and the portable information process device 100. In step 404, data transmission is initiated. The touch locus on the touch-control panel 200 user is converted into a locus of the mouse displayed on a display interface 160. Similarly, signals of the functional keys 251 selected by the remote control module 250 are also transmitted to and executed in the portable information process device 100.

While the present invention has been particularly shown and described with reference to preferred embodiments thereof, it will be understood by those of ordinary skill in the art that the various changes in form and detail may be made therein without departing from the spirit and scope of the present invention, as defined by the appended claims.

What is claimed is:

1. A wireless touch-control panel applied to a portable information process device, comprising:
a touch-control panel, having a sensor plane allowing a user to touch;
a sensor circuit, operative to receive and identify signals input by touch of the user, and to generate command signals corresponding to the input signals;
an antennal built in the touch-control panel; and
a wireless module to transmit the command signals to the portable information process device via the antenna.

2. The panel of claim 1, further comprising a remote-control module that has a plurality of functional keys.

3. The panel of claim 1, wherein the wireless module uses radio frequency microwave to communicate the portable information process device.

4. The panel of claim 1, wherein the wireless module uses Bluetooth wireless communication to communicate the portable information process device.

5. The panel of claim 1, wherein the antenna includes a built-in directionless antenna.

6. An information process system, comprising:
a portable information process device used to perform data process, the portable information process device having a display interface;
a touch-control panel, having a sensor plane allowing a user to touch, the touch-control panel wireless control the display interface;
a sensor circuit for receiving and identifying input signals generated by touch on the sensor plane, and generating output signals corresponding to the input signals;
an antenna built in the touch-control panel; and
a wireless module to transmit the output signals to the portable information process device via the antenna.

7. The system of claim 6, wherein the portable information process device further comprises a receiving slot for receiving the wireless touch-control panel therein.

8. The system of claim 6, wherein the wireless control panel further comprises a remote-control module that has a plurality of functional keys.

9. The system of claim 6, wherein the wireless module uses RF microwave to communicate the portable information process device.

10. The system of claim 6, wherein the wireless module uses Bluetooth wireless protocol to communicate the portable information process device.

11. The system of claim 6, wherein the antenna includes a built-in directionless antenna.
